(19) United States
(12) Patent Application Publication
(10) Pub. No.: US 2022/0295962 A1
(43) Pub. Date: Sep. 22, 2022

(54) DEVICE FOR PICKING UP AND APPLYING A COSMETIC PRODUCT

(71) Applicant: L'OREAL, Paris (FR)

(72) Inventors: Karl-Joseph RIZZO, Chevilly Larue (FR); Franck GIRON, Chevilly Larue (FR); Henri SAMAIN, Chevilly Larue (FR); Jean-Baptiste BLANC, Chevilly Larue (FR)

(21) Appl. No.: 17/617,754

(22) PCT Filed: Jun. 15, 2020
(86) PCT No.: PCT/EP2020/066504

§ 371 Date: Dec. 9, 2021

(30) Foreign Application Priority Data
Jun. 28, 2019 (FR) FR1907100

(51) Int. Cl. A45D 19/02; A45D 34/04; A45D 40/26; B33Y 80/00; B41K 1/28; B41K 1/22; B41K 1/56; B41M 5/025

(52) U.S. Cl. CPC A45D 19/02; A45D 34/04; A45D 40/26; B33Y 80/00; B41K 1/28; B41K 1/22; B41K 1/56; B41M 5/0256; A45D 2029/005

(57) ABSTRACT

A device for picking up and applying a cosmetic composition, in particular makeup, having a flexible support defining an, in particular continuous, application surface intended to receive the cosmetic composition, and at least two elements that are movable with respect to one another and are connected to the support, such that a relative movement of these two elements brings about a mechanical stress on the support and causes the latter to deform between a configuration for picking up cosmetic composition and an application configuration.

### TECHNICAL FIELD

The present invention relates to a device for picking up and applying a cosmetic composition, in particular makeup, having a support defining an application surface suitable for receiving the cosmetic composition. The invention also relates to methods for manufacturing such a device and cosmetic treatment, in particular makeup, methods using same.

### PRIOR ART

Many people apply makeup to their face in order to conceal certain imperfections or to improve their physical attractiveness, by trying to be as attractive and original as possible. This leads to a desire for out-of-the-ordinary makeup, that is to say makeup that other people do not wear and, if possible, would not be able to copy.

Using known makeup products, it is possible to realize numerous makeup effects, in particular on the eyelids, but these are rather limited to solid flat colour tints, or to a graduated effect based on two or three colours. In both cases, a coloured fluid or powder is applied by finger or using an applicator, for example a brush, and is spread by blending. This step does not make it possible to realize complex patterns. Although it is quite possible to produce graduated effects based on two colours, it is difficult to master this, so people tend to choose two fairly similar colours rather than choosing two very different colours. In doing so, the risks of mistakes are limited, but the graduated effect is sometimes so subtle that it is hardly visible.

One known approach consists in using printable films known as decal films, which, when applied, transfer a pattern to the skin. This approach is not very satisfactory since it is very impractical, in particular for application in raised, domed or recessed areas, and even more so for complex areas such as the eyes, which combine domed and recessed areas. When the user comes to apply the decal film, some parts of the pattern are transferred and others are not. The result is thus often unattractive and difficult to put right, making it necessary to remove the makeup and start again.

This drawback can be alleviated by providing decal portions with a small surface area, it being understood that a raised area can be considered to be a large number of virtually flat patches. However, this approach is time consuming since it requires a large number of actions, and creates risks of one portion being positioned poorly with respect to the others. As a result, decal films have not been developed as common makeup approaches.

Another approach consists in attaching, in particular flexible, stickers to the skin. This approach is unsatisfactory since it is necessary, at a given time, to detach the stickers, causing discomfort and tugging on the skin, this being particularly disagreeable in the area of the eyes. In addition, if the application is not carried out perfectly, it results in an especially unattractive effect. Moreover, since the sticker is made of a flexible material, it is possible to conform it to a surface having an axis of curvature, such as a cylinder, but not to a more complex surface, such as a spheroid.

The application of a decal film or a sticker to such an area involves stretching it in certain directions, producing return forces, and thus creases or detachment, in particular at the edges. Thus, while the sticker solution may be suitable for certain areas that are rather flat, for example to reproduce a liner effect on the eyelid, it cannot be used for areas having recesses and domed parts, in particular the area of the eyelids, the lips or the nose, unless a large number of stickers are applied. In this case, the positioning problems mentioned above for decals arise again.

Another approach consists in using a three-dimensional applicator, on the surface of which a layer of coloured material is placed. Although this approach may be suitable for applying a flat colour tint, it is not suitable for creating patterns.

Applicators for applying makeup to the eyelids by transfer exist, such as the one from Huadi© Pretty: Glittering Eyeshadow to Seal. This applicator comprises a rubber support having the approximate shape of an eyelid. In order to apply makeup, it is necessary to brush the makeup onto the recessed concave part of the support and then to use the applicator to transfer the makeup to the eyelid. In the case of simple makeup, that is to say of a single colour, the applicator makes it possible to apply the colour to a surface in a reproducible manner.

Tests have been carried out involving painting or drawing a pattern on the surface of said support with a makeup fluid. However, since users generally have limited dexterity, the results are generally disappointing and asymmetric from one eye to the other, or from one day to another.

Other tests have been carried out in which this type of applicator was employed in combination with a decal film. If the film is applied with the colouring layer towards the outside, the application of the film to the surface of the 3D applicator mars the pattern during the operation, in particular on account of the effect of the fingers, causing partial transfer to the latter. Thus, only a part of the pattern remains on the applicator, resulting in limited transfer of the pattern to the face, and an imperfect end result.

If the decal film is applied with the colouring layer towards the inside and then the film is removed, the pattern is located on the surface of the 3D applicator, but, upon contact with the skin, limited transfer of the pattern to the face is obtained.

Internal tests have shown that, in order to transfer a pattern effectively via such an applicator, it was necessary for the layer of colouring material to be easier to transfer to the skin, for example by employing patterns referred to as “fragile”, that is to say produced with a layer of colouring material which, when applied to a first surface, upon slight contact with a second surface, disintegrates or breaks up to pass from the first surface to the second. These fragile patterns can be realized in the form of free powder or fluid.

However, there is no known solution that is suitable for using such a fragile pattern, since it is virtually impossible to apply it to the surface of the applicator without taking extreme precautions. Simple contact with the fingers, or the pressure brought about by it being positioned on the surface of the applicator, damages the pattern, in particular causing it to become blurred and/or to come away in certain parts.

Another known approach consists in using a soft material, such as a sponge, and then depositing a layer of makeup composition on the surface thereof. All that is necessary is to press the sponge onto the area to be made up. However, it has been found the makeup composition spreads during the operation, causing slippage effects of the pattern, and damaging the pattern to such an extent as to make it unrecognizable.

The application WO 2015/097613 describes a method for applying makeup to an area of human keratin materials with the aid of a makeup device having a deformable substrate with a transfer surface that is intended to receive a cosmetic ink deposited via a digital printer and to come into contact with the keratin materials, the substrate being pressed against an imprint of the support through the action of deformation means such as negative pressure before the transfer surface is brought into contact with the area to be made up using a mechanical action. Such a device has a fairly complex structure.

U.S. Pat. No. 6,435,195 describes an applicator for applying a product, includes a handling element secured to an application member. The application member includes a base and an application support is mounted on the application member. The application support defines an application surface. The applicator includes a manipulation member designed to alter a profile of the application surface at right angles to a mid-plane of the base. A portion of the manipulation member extends through the at least one passage so that the manipulation member can be placed in engagement with the application support so as to alter the profile of the application surface.

U.S. Pat. No. 5,470,163 discloses a collapsible applicator adapted to be folded into a convenient, thin and elongated size to be placed into a bottle of fluid. After removal of the applicator from the bottle it may be expanded in an umbrella like fashion to provide a handle, an elongated, central frame member attached to applicator members extending outwardly.

Patent application FR 847 952 describes an automatic puff arranged in a compact.

U.S. Pat. No. 4,869,612 presents an improved liquid applicator including a bottle for holding suntan lotion with a cap for closing the bottle. The inner surface of the cap is coupled to a shaft having a plurality of applicator pads coupled to its end. An actuator sleeve surrounding a portion of the shaft and coupled to the applicator pads which resiliently urge the sleeve toward the cap is provide. The end of the sleeve closest to the cap includes a cam which operates in cooperation with a mating surface on the inner side of the cap to allow the actuator sleeve to be locked into a position which urges the applicator pads away from the shaft.

International application WO 92/11785 discloses a mascara applicator having a brush which can be adjusted by a user from straight to curved comprising a wand within which is slidably disposed an adjusting rod connecting to manipulating means within the applicator handle. The rod is extendable into an applicator head on the end of the wand and may be straight so as to straighten a precurved applicator or curved so as to impart curvature to a straight applicator.

Patent application FR 2 506 581 describes a make-up brush including a bellows or longitudinally slit sleeve defining bristles and adapted to be varied in diameter, by variation in length, so as to suit the wishes of a user or the properties of a make-up product to be applied.

Patent application FR 2 999 885 presents an application device for applying a cosmetic composition, comprising: a gripping element; a first head including a first surface, a rod connecting the gripping element and the first head and extending along the length of a longitudinal axis, and a second head mounted on the gripping element and comprising a second surface. The first and second heads are mounted such that they can move in relation to one another along the length of the longitudinal axis between an open position in which the first and second surfaces are at a distance from one another and a closed position in which the first and second surfaces are applied against one another.

### PRESENTATION OF THE INVENTION

Consequently, there is a need to further improve the application of makeup to human keratin materials, in order to realize patterns, in particular on the face, including in areas having raised portions, precisely and easily, and without risking any deterioration of the patterns.

The present invention aims in particular to meet this need.

### SUMMARY OF THE INVENTION

Therefore, the subject of the invention is a device for picking up and applying a cosmetic composition, in particular makeup, having a flexible support defining an application surface, preferably continuous, intended to receive the cosmetic composition, and at least two elements that are movable with respect to one another and are connected to the support, such that a relative movement of these two elements brings about a mechanical stress on the support and causes the latter to deform between a configuration for picking up cosmetic composition and an application configuration.

Preferably, the cosmetic composition is in the form of a transferable print, forming in particular a pattern.

The term “human keratin materials” refers to the skin, including the scalp, the lips, the nails, the hair and the eyebrows, and preferably the lips or the facial skin, in particular that of the eyelids or of the cheeks. The invention applies very particularly to the application of makeup to the eyelids.

The invention makes it possible to easily pick up a film printed on a flat transfer surface, without damaging said film, by using the first configuration of the support, that is to say the pick-up configuration.

By virtue of the invention, the makeup, in particular in the case of a pattern, is applied faithfully while following the relief of the area in question, using the second configuration of the support, that is to say the application configuration. The application surface thus advantageously has a morphological shape, adapted to the area to which the composition is intended to be applied.

The support advantageously passes from one configuration to the other, and vice versa, without it being necessary to apply a pressure manually to the application surface by touching it.

### Configurations

In the first configuration of the support, the application surface can form a developable surface. In this configuration, the application surface can be a part of a cylinder. In this case, the support makes it very particularly possible to pick up a transferable print from the surface of an applicator roller or from the outer face of a domed pad. In this configuration, the application surface can have a shape opposite to that taken up in the second configuration of the support.

Preferably, in the first configuration of the support, the application surface is substantially flat.

In the second configuration of the support, the application surface is preferably curved. In this configuration, the application surface can have a shape that is concave towards the outside. This makes it possible to conform to the relief of the eyelid, for example.

The application surface, in the second configuration of the support, can thus have a shape adapted to the application of the cosmetic composition to an eyelid.

In one variant, in the second configuration of the support, the application surface has a shape that is convex towards the outside.

In the second configuration of the support, the application surface can have a shape that corresponds exactly to a predefined area of the face or of the body of a user. In this case, the support is advantageously produced on the basis of an acquisition of the topography of at least a part of said area, in particular by way of a 3D scan. This makes it possible to obtain a customized, tailor-made application surface.

The maximum travel of the application surface between the two configurations of the support may be between 5 mm and 40 mm, better still between 7 mm and 20 mm. This travel is advantageously measured at one of the ends of the support, at its periphery, between the two configurations.

It is possible for the device to take up only the two configurations in a stable manner, the passage from one configuration to the other taking place for example automatically as a result of the user acting on the device.

The device can be returned automatically, as soon as the user releases it, into one of the configurations by an elastic return member and/or by the inherent shape of the support, when the latter is elastically deformable.

### Support and Movable Elements

The support may exhibit or be constituted of a deformable material, in particular a thermoplastic and/or elastomeric material. The support may be elastically deformable, being returned by elasticity into its initial configuration, which may be the application configuration or the pick-up configuration, preferably the application configuration. The support may be single-layered or multi-layered.

The support may exhibit at least one elastomer chosen from the following non-limiting list: copolymerized butadiene-styrene, butadiene-nitrile, isobutylene-isoprene, copolymerized chloroethylene-polysulfide, polysulfides, EPDM (ethylene-propylene-diene monomer) or polyethylene-propylene diamine or polyurethanes, or a silicone elastomer, for example VMQ (vinyl methyl silicone) or MQ, FVMQ (fluorosilicone), PVMQ (phenyl silicone).

The support may be non-absorbent. The support is advantageously non-porous, at least at the application surface intended to receive the cosmetic composition. The application surface may be relatively smooth.

The device according to the invention has at least two elements that are movable with respect to one another, as indicated above. One of these elements can be fixed relative to the support, in particular fixed at its centre, and the other element can act on the periphery of the support. In one example, one of said two movable elements has at least two mechanical connections that connect the support by two respective contact points to an actuating element that is movable relative to the support and configured to be actuated by the user in order to change the configuration of the support. The abovementioned connections can be flexible, being for example wires.

The actuating element can at least partially define a gripping surface of the device.

The actuating element may be rotatable about a geometric axis with respect to a physical axis fixed to the support, in particular perpendicular to the support, so as, when driven in rotation, to stretch the connections such that the latter exert a pull on the support at the periphery thereof so as to change it from one configuration to the other.

In this particular embodiment, the device can be configured such that the user can turn the actuating element until a stop is reached. The return to the starting configuration can be performed by releasing the actuating element, by virtue of the inherent elasticity of the support.

In one variant, the connections are rigid and are each formed by an arm connecting the actuating element to the support, the device being configured such that a movement of said actuating element acts on the connections and the support. The movement of the two abovementioned elements can be a pushing or pulling movement of one element relative to the other, which is converted into a movement of the connection or connections connected to the support, for example a rotational movement of these connections.

For example, the device has an actuating element in the form of a push button, which the user presses in order to deform the support. This push button may be movable relative to the body of the device, which defines the gripping part and may be provided with fins for holding the device when the user presses the push button. The connections may be hinged to said body and be moved by the movement of the push button.

The fins may define two ergonomic rests configured to receive the fingers of a user in order to hold the device while another finger presses the push button. In order to change configuration, the user presses the push button, causing the connections to pivot and to deform the support. The body of the device is preferably fixed relative to the support, being for example fixed at the centre thereof.

In one variant, the support has an elastically deformable membrane defining the application surface and the device has, on the opposite side from said application surface, a bearing element separate from said membrane, in particular made of a rigid material. The device advantageously has a rod that carries the membrane and is able to move relative to the bearing element such that, as a result of the rod being pulled towards the rear, the membrane is pressed against the bearing element and takes on the shape thereof.

In this embodiment, the rod may have a relief configured to lock the support in the application configuration, in particular by snap-fastening of the rod to the bearing element.

In a variant, the rod is movable about its axis and bears at least one relief for locking in position through a quarter turn.

The membrane may be fixed to the rod at a single, in particular central, contact point.

In yet another variant, the movable elements are elastically deformable so as to be able to be moved towards one another. The mobility of the elements thus results from their deformation. The device may have two elastically deformable connections that connect the support by two respective contact points to a fixed rod, the connections being configured to move towards one another. When the user presses the connections between their thumb and index finger, the application surface, which is curved in a first configuration, is advantageously flattened. The connections may exhibit at least one elastomer, in particular rubber or silicone.

Said at least two movable elements may be configured to exert on the support a mechanical force applied by the user, in particular via a gripping part of the body of the device.

In a variant, the device is designed to restore a stored mechanical force, in particular stored by a spring, in order to pass from one configuration to another.

In one variant, the device has an electrical system, in particular a motor, for passing from one configuration to the other.

In yet another variant, the device is configured so as to exert on the support a hydraulic or pneumatic force, in particular by way of inflated ducts, or a magnetic force, in particular by way of magnets, in order to pass from one configuration to the other.

The shape of the support is preferably modifiable reversibly between the first configuration and the second.

### Application Surface and Composition

In order to improve contact while the composition is being picked up, the part of the support defining the application surface may exhibit or be constituted of a silicone elastomer layer.

The cosmetic composition is preferably in the form of a print on a flat transfer surface, the application surface being brought into contact therewith in the pick-up configuration of the applicator. The cosmetic composition may be deposited on the transfer surface in the form of printed coloured patterns. The print may be applied to a film made of plastics material.

The printer may be a digital printer, in particular a laser printer designed to allow the formation by electrophotography or magnetophotography of a layer of composition having a pattern on a transfer surface using at least one cosmetic toner and to dispense the toner present on the transfer surface in a state that is sufficiently free to allow it to be picked up or transferred by contact with the human keratin materials.

The term “cosmetic toner” should be understood to mean a pulverulent cosmetic composition that is compatible with the formation of an image via an electrophotographic or magnetophotographic process as used in laser printers. The toner is cosmetic in that it is compatible with application to human keratin materials. Depending on the surface to be made up, the formulation of the toner may be different. For example, for application to the hair or nails, it is possible to use certain compounds that might not be used for application to the lips, for example.

The laser printer may have a deactivated fuser.

In variants, the printer is an inkjet printer, for example a thermal or piezoelectric inkjet printer, or a sublimation printer.

In the case of a cosmetic composition in the form of a transferable print, the print may be realized in the form of raster spots so as to form a monochromatic or polychromatic halftone image, for example.

The pattern formed by printing may be of any type. This pattern may reproduce the appearance of relief and/or colour heterogeneities of the skin, for example freckles or a mole.

The pattern obtained by printing may have several areas of different colours. In a variant, the pattern obtained by printing is a flat tint.

The cosmetic composition may be in a fluid or pulverulent form when carried by the application surface and before application to the keratin materials.

When it is fluid, the cosmetic composition has, for example, a viscosity ranging from 1 mPa·s to 500 mPa·s and preferably from 1 mPa·s to 300 mPa·s at 25° C.

The viscosity of a composition used in the invention may be measured using any method known to a person skilled in the art, and in particular according to the following conventional method. At 25° C. using a Rheomat 180 viscometer, equipped with a spindle rotating at 200 rpm, a person skilled in the art can select the spindle for measuring the viscosity from the spindles M1, M2, M3 and M4 on the basis of his general knowledge, so as to be able to perform the measurement.

The cosmetic composition may be in the form of a transferable print corresponding to a layer of powder, containing in particular pigments, or to a thickness of fluid, deposited by inkjet for example, containing one or more dyes and/or one or more pigments.

The cosmetic composition may include one or more colourants chosen from water-soluble dyes, liposoluble dyes, pulverulent colourants such as pigments, lakes, nacres, and glitter flakes, or colouring polymers.

The term “pigments” should be understood to mean white or coloured, mineral or organic particles of any form, which are insoluble in the cosmetic medium and are intended to colour the cosmetic composition.

The term “organic lakes” should be understood to mean particles formed from a dye fixed to a substrate.

The term “nacres” should be understood to mean iridescent particles of any form, in particular produced by certain molluscs in their shell, or synthesized.

The pigments may be white, black or coloured, and mineral and/or organic. Among the mineral pigments that may be mentioned are titanium dioxide, optionally surface-treated, zirconium oxide or cerium oxide, and also zinc oxide, iron (black, yellow or red) oxide or chromium oxide, manganese violet, ultramarine blue, chromium hydrate and ferric blue, and metal powders, for instance aluminium powder and copper powder.

Among the organic pigments that may be mentioned are carbon black, pigments and lakes of D & C type and lakes based on cochineal carmine or on barium, strontium, calcium or aluminium.

The nacres may be chosen from white nacres such as mica coated with titanium or with bismuth oxychloride, coloured nacres such as titanium mica coated with iron oxides, titanium mica coated in particular with ferric blue or with chromium oxide, titanium mica coated with an organic pigment, and nacreous pigments based on bismuth oxychloride.

Among the water-soluble dyes that may be mentioned are the disodium salt of ponceau, the disodium salt of alizarin green, quinoline yellow, the trisodium salt of amaranth, the disodium salt of tartrazine, the monosodium salt of rhodamine, the disodium salt of fuchsin, xanthophyll and methylene blue.

Among the liposoluble dyes that may be mentioned are Sudan Red III (CTFA: D&C Red 17), lutein, quinizarine green (CTFA: D&C Green 6), alizurol purple SS (CTFA: D&C Violet no. 2), Sudan Brown, DC Yellow 11, DC Orange 5, quinoline yellow, curcumin, and carotenoid derivatives such as lycopene, beta-carotene, bixin or capsanthin, and mixtures thereof. The colouring polymers are generally copolymers based on at least two different monomers, at least one of which is a monomeric organic dye. Such polymeric dyes are known to a person skilled in the art. Reference may be made, for example, to the following documents: U.S. Pat. Nos. 5,032,670; 4,999,418; 5,106,942; 5,030,708; 5,102,980; 5,043,376; 5,104,913; 5,281,659, 5,194,463; 4,804,719; WO92/07913, or EP1048282.

The cosmetic composition may include one or more colourants, in particular photochromic pigments, i.e. colourants which have the property of changing colour when they are irradiated with a light source of a certain frequency, and then of regaining their initial colour, or a similar colour, when the irradiation is stopped. Among the photochromic colourants that may be mentioned are, in particular:
complex mineral photochromic compounds and more particularly doped aluminosilicates and metal oxides and metal oxide hydrates, such as those described in WO-A-02/36083;
photochromic naphthopyran compounds, in particular 3H-naphtho[2,1-b]pyrans or 2H-naphtho[1,2-b]pyrans, for example 3,3-bis(4-methoxyphenyl)-6-morpholino-3H-naphtho[2,1-b]pyran, 3-phenyl-3-(4-morpholinophenyl)-6-morpholino-3H-naphtho[2,1-b]pyran, 3-phenyl-3-(4-piperidinophenyl)-6-morpholino-3H-naphtho[2,1-b]pyran, 3-phenyl-3-(4-piperidinophenyl)-6-carboxymethyl-9-N-dimethyl-3H-naphtho[2,1-b]pyran or 2-phenyl-2-(4-piperidinophenyl)-5-carboxymethyl-9-N-dimethyl-2H-naphtho[1,2-b]pyran.

Such compounds are described in the application EP-A-1410785;
diarylethene or fulgide compounds such as those described in the application EP-A-938887.

The cosmetic composition may also include one or more fillers, in particular in a content ranging from 0.01% to 50% by weight, relative to the total weight of the composition, preferably ranging from 0.01% to 30% by weight.

The term “fillers” should be understood to mean colourless or white, mineral or synthetic particles of any shape, which are insoluble in the medium of the composition, irrespective of the temperature at which it is manufactured. These fillers serve in particular to modify the rheology or texture of the composition.

The fillers may be mineral or organic and of any shape, platelet-shaped, spherical or oblong, irrespective of the crystallographic form (for example lamellar, cubic, hexagonal, orthorhombic, etc.). Mention may be made of talc, mica, silica, kaolin, polyamide powder (Nylon) (Orgasol from Atochem), poly-β-alanine powder and polyethylene powder, powders of tetrafluoroethylene polymers (Teflon), lauroyllysine, starch, boron nitride, hollow polymer microspheres such as those of polyvinylidene chloride/acrylonitrile, for instance Expancel (Nobel Industrie), or of acrylic acid copolymers (Polytrap from the company Dow Corning) and silicone resin microbeads (for example Tospearls from Toshiba), elastomeric polyorganosiloxane particles, precipitated calcium carbonate, magnesium carbonate, magnesium hydrocarbonate, hydroxyapatite, hollow silica microspheres (Silica Beads from Maprecos), glass or ceramic microcapsules, and metal soaps derived from organic carboxylic acids containing from 8 to 22 carbon atoms and preferably from 12 to 18 carbon atoms, for example zinc, magnesium or lithium stearate, zinc laurate or magnesium myristate.

The cosmetic composition may also include an additional polymer such as a film-forming polymer. The term “film-forming polymer” is understood to mean a polymer that is capable of forming, by itself or in the presence of an auxiliary film-forming agent, a continuous film that adheres to a support, in particular to keratin materials. Among the film-forming polymers that can be used in the composition, mention may be made of synthetic polymers, of radical type or of polycondensate type, polymers of natural origin and mixtures thereof, in particular acrylic polymers, polyurethanes, polyesters, polyamides, polyureas, and cellulose-based polymers such as nitrocellulose.

Needless to say, a person skilled in the art will take care to select this or these optional additional compound(s), and/or the amount thereof, such that the advantageous properties of the composition are not, or are not substantially, adversely affected by the envisaged addition.

When the composition is based on a cosmetic toner as described above, this toner may include, besides a colouring agent, a compound for controlling the electrical charge, a particular additional filler, a lubricant, a wax and/or a binder. Preferably, the particles of the toner have a mean size of between 1 and 16 μm. The toner includes for example pigments with a particle size of between 1 and 10 μm.

The composition may include both a hydrophilic phase containing one or more compounds that are miscible with water at 20° C. and an oily phase containing one or more water-immiscible compounds.

At an ambient temperature of 20° C., the hydrophilic phase may form a dispersed phase in a continuous phase formed by the oily phase; a water-in-oil (W/O) emulsion is thus obtained. In one variant, the oily phase forms at 20° C. a dispersed phase in a continuous phase formed by the hydrophilic phase; an oil-in-water (O/W) emulsion is thus obtained. The hydrophilic phase and/or the oily phase may each include one or more colourants.

The composition may include a surfactant in order to obtain an oil-in-water emulsion, or a water-in-oil surfactant. It may be chosen from hydrocarbon-based or silicone surfactants, the HLB of which will be chosen depending on the desired direction of emulsion, for example less than 8 for W/O emulsions, advantageously from 3 to 7, and for example greater than or equal to 8 for direct emulsions.

Examples of silicone surfactants that may be mentioned are those of the alkyldimethicone copolyol type and of the dimethicone copolyol type.

Examples of non-silicone surfactants that may be mentioned are non-ionic surfactants such as the (poly)oxyalkylenated (C2-C3 alkyl), (poly)glycerolated derivatives of alcohols, of esters, of ethers comprising at least one hydrocarbon-based group with at least 10 carbon atoms, potentially (poly)oxyalkylenated, (poly)glycerolated sorbitan esters or ethers; alkyl polyglucosides and mixtures thereof.

The anionic surfactants may be chosen for example from alkyl (ether) sulfates, sulfonates, (alkyl)phosphates, salts, in particular metal salts, of C10-C30 acids; these surfactants comprising at least one hydrocarbon-based group with at least 10 carbon atoms which may or may not be (poly)oxyalkylenated (C2-C3 alkyl); and mixtures thereof.

The compound(s) of the oily phase may have a solubility in water at 25° C. of less than 5% by weight.

The compound(s) of the oily phase may be chosen from the oils usually used in cosmetics, which may be chosen from natural or synthetic, hydrocarbon-based, silicone or fluoro oils, which are optionally branched, alone or as a mixture.

The term “non-volatile oil” is understood to mean an oil that is capable of remaining on the skin at ambient temperature and atmospheric pressure for at least one hour, and in particular having a non-zero vapour pressure at ambient temperature (25° C.) and atmospheric pressure of less than 0.01 mmHg (1.33 Pa).

Mention may be made in particular of non-volatile hydrocarbon-based oils, in particular of plant, mineral, animal or synthetic origin, such as liquid paraffin (or petroleum jelly), squalane, hydrogenated polyisobutylene (Parleam), perhydrosqualene, macadamia oil, soybean oil, sweet almond oil, beauty-leaf oil, palm oil, grapeseed oil, sesame oil, corn oil, arara oil, rapeseed oil, sunflower oil, cotton oil, apricot oil, castor oil, avocado oil, jojoba oil, olive oil or cereal germ oil, shea butter oil; linear, branched or cyclic esters containing more than 6 carbon atoms, in particular 6 to 30 carbon atoms, such as esters of lanolic acid, of oleic acid, of lauric acid or of stearic acid; esters derived from long-chain acids or alcohols (i.e. containing from 6 to 20 carbon atoms), in particular the esters of formula RCOOR′, in which R represents a higher fatty acid residue containing from 7 to 19 carbon atoms and R′ represents a hydrocarbon-based chain containing from 3 to 20 carbon atoms, in particular C12-C36 esters, such as isopropyl myristate, isopropyl palmitate, butyl stearate, hexyl laurate, diisopropyl adipate, isononyl isononanoate, 2-ethylhexyl palmitate, 2-hexyldecyl laurate, 2-octyldecyl palmitate, 2-octyldodecyl myristate or lactate, bis(2-ethylhexyl) succinate, diisostearyl malate, and glyceryl or diglyceryl triisostearate; higher fatty acids, in particular of C14-C22, such as myristic acid, palmitic acid, stearic acid, behenic acid, oleic acid, linoleic acid, linolenic acid or isostearic acid; higher fatty alcohols, in particular of C16-C22, such as cetanol, oleyl alcohol, linoleyl alcohol or linolenyl alcohol, isostearyl alcohol or octyldodecanol; and mixtures thereof.

Mention may also be made of decanol, dodecanol, octadecanol, liquid fatty acid triglycerides of 4 to 10 carbon atoms such as heptanoic or octanoic acid triglycerides, caprylic/capric acid triglycerides; linear or branched hydrocarbons, of mineral or synthetic origin such as liquid paraffins and derivatives thereof, petroleum jelly, polydecenes and hydrogenated or non-hydrogenated polyisobutenes such as Parleam; synthetic esters and ethers in particular of fatty acids, for instance purcellin oil, isopropyl myristate, 2-ethylhexyl palmitate, 2-octyldodecyl stearate, 2-octyldodecyl erucate or isostearyl isostearate; hydroxylated esters such as isostearyl lactate, octyl hydroxystearate, octyldodecyl hydroxystearate, diisostearyl malate, triisocetyl citrate or fatty alcohol heptanoates, octanoates and decanoates; polyol esters such as propylene glycol dioctanoate, neopentyl glycol diheptanoate or diethylene glycol diisononanoate; and pentaerythritol esters; fatty alcohols containing from 12 to 26 carbon atoms, such as octyldodecanol, 2-butyloctanol, 2-hexyldecanol or 2-undecylpentadecanol.

Among the non-volatile silicone oils, mention may be made of non-phenyl silicones, such as in particular polysiloxanes (also known as dimethicone). Also suitable are phenyl silicones (in other words silicones comprising at least one phenyl substituent), for instance phenyl trimethicones, trimethyl pentaphenyl trisiloxanes, tetramethyl tetraphenyl trisiloxanes, diphenyl dimethicones, trimethylsiloxyphenyl dimethicones and diphenylsiloxyphenyl trimethicones, alone or as mixtures.

Among the volatile compounds, mention may be made of non-silicone volatile oils, in particular C8-C16 isoparaffins, such as isododecane, isodecane and isohexadecane.

Linear or cyclic, but preferably linear, volatile silicone oils may also be suitable, such as in particular decamethyl tetrasiloxane, dodecamethyl pentasiloxane and mixtures thereof.

More preferably, mention may be made of volatile or non-volatile alkanes that are liquid at ambient temperature, and more particularly decane, heptane, dodecane, isododecane, isohexadecane, cyclohexane and isodecane, and mixtures thereof.

Among the preferred compounds of the oily phase, examples that may be mentioned include isododecane (boiling point: 180° C.), isopropyl myristate (boiling point: 168° C.), isostearyl alcohol (boiling point: 331° C.), isodecyl neopentanoate (boiling point: 272° C.), isononyl isononanoate (boiling point: 285° C.), oleyl alcohol (boiling point: 315° C.), 2-octyldodecanol (boiling point: 358° C.), isopropyl palmitate (boiling point: 340° C.), isopropyl isostearate (boiling point: 361° C.), and mixtures thereof.

The oil may be present in the composition in a content ranging from 2% to 60% by weight relative to the total mass of the composition, preferably ranging from 2% to 40%, preferably ranging from 15% to 70% and particularly preferably ranging from 2% to 25%.

The oily phase may also comprise substances that are solid at room temperature, such as waxes.

The term “wax” is understood to mean a lipophilic compound, which is solid at ambient temperature (25° C.), with a reversible solid/liquid change of state, having a melting point of greater than or equal to 30° C., which may be up to 120° C. By bringing the wax to the liquid state (melting), it is possible to make it miscible with the oils that may be present and to form a microscopically homogeneous mixture, but on returning the temperature of the mixture to ambient temperature, recrystallization of the wax in the oils of the mixture is obtained. The melting point of the wax may be measured using a differential scanning calorimeter (D.S.C.), for example the calorimeter sold under the name DSC 30 by the company Mettler.

The waxes may be hydrocarbon-based waxes, fluoro waxes and/or silicone waxes, and may be of plant, mineral, animal and/or synthetic origin. In particular, the waxes have a melting point of greater than 25° C. and better still greater than 45° C. As waxes that may be used in the composition, mention may be made of beeswax, carnauba wax or candelilla wax, paraffin, microcrystalline waxes, ceresin or ozokerite; synthetic waxes such as polyethylene waxes or Fischer-Tropsch waxes, silicone waxes such as alkyl or alkoxy dimethicones containing from 16 to 45 carbon atoms.

The nature and amount of the waxes depend on the desired mechanical properties and textures. As a guide, the composition, in particular in the form of an emulsion, may contain from 0.01 to 30% by weight of waxes relative to the total weight of the cosmetic composition, and better still from 1% to 20% by weight.

### Manufacturing Method

A further subject of the invention, according to another of its aspects, is a method for manufacturing a device for picking up and applying a cosmetic composition according to the invention, wherein the application surface of the support, in the second configuration, is given a shape adapted to the area of the body or of the face to which the composition is intended to be applied, said area being in particular an eyelid.

In the second configuration, the relief of the support may correspond exactly to the relief of the area to be made up, thereby forming a “counter-mould” of said area.

At least a part of the device having the application surface is advantageously produced by machining a preform or by additive manufacturing, in particular by 3D printing. In one variant, a mould used for manufacturing at least a part of the device having the application surface is advantageously produced by machining a preform or by additive manufacturing, in particular by 3D printing.

The method may include a preliminary step of creating an imprint. The imprint may in particular be created by direct moulding of the area to be made up or indirectly on the basis of such moulding, for example with the aid of an intermediate mould.

The support may have been produced on the basis of an acquisition, in particular an optical acquisition, of the topography of at least a part of said area of the human keratin materials, in particular by way of a 3D scan.

In order to carry out the 3D scan, it is possible to use any 3D scanner capable of capturing the volume and the dimensions of the area in question. The 3D scan is advantageously a scan produced by projecting fringes of light, but any other structured light is possible.

A file that is readable by a CNC machine or by a 3D printer is advantageously generated, said file being able to be saved, in particular automatically, for example in the cloud or on a central server.

A translated digital copy of a surface, possibly a reworked surface, obtained from the 3D scan, is advantageously created, and then a smoothed volume of the part of the device having the application surface or of the mould between said surface and the translated copy thereof may be generated.

### Set

A further subject of the invention, according to another of its aspects, is a cosmetic set having, within one and the same packaging, at least one pick-up and application device according to the invention, and a plurality of transferable prints that are intended to be picked up by the application surface of the support in its first configuration and in particular differ from one another in terms of their composition and/or their pattern, in particular as defined above.

The prints are preferably obtained using a laser printer or inkjet printer.

### Cosmetic Treatment Method

A further subject of the invention, according to another of its aspects, is a method for the cosmetic treatment of an area of human keratin materials, in particular for applying makeup thereto, involving the application of a cosmetic composition to said area with the aid of a pick-up and application device according to the invention, wherein, in said method, the device is used in its first configuration to pick up said composition, the latter being in particular in the form of a transferable print, and then the device is put into its second configuration by acting on at least one of said two movable elements, before the composition is applied.

In one exemplary embodiment, the composition is in the form of a print with a predefined pattern, the method including a step of a user choosing and/or creating the pattern and of information relating to this pattern being transmitted by means of a machine connected to at least one printer that carries out the printing.

The machine may be a computer, an advanced mobile telephone, also known as a “smartphone”, or a tablet computer. The machine may be connected to said printer physically and/or by way of a data exchange network. During the printing step, the system may be at least partly fitted to the printer.

The features mentioned above for the methods apply to the device, and vice versa.

### BRIEF DESCRIPTION OF THE DRAWINGS

The invention may be understood better from reading the following detailed description of non-limiting exemplary embodiments thereof and from examining the appended drawing, in which:

FIG. 1 shows an example of a device for picking up and applying a cosmetic composition according to the invention,

FIG. 2 is a view in longitudinal section on II-II of the device in FIG. 1,

FIG. 3 illustrates an example of two configurations that the support of a device according to the invention can take up,

FIG. 4 shows a second example of a device according to the invention,

FIG. 5 shows a third example of a device according to the invention,

FIG. 6 shows a fourth example of a device according to the invention, and

FIGS. 7, 8 and 9 illustrate an example of the use of a pick-up and application device according to the invention.

### DETAILED DESCRIPTION

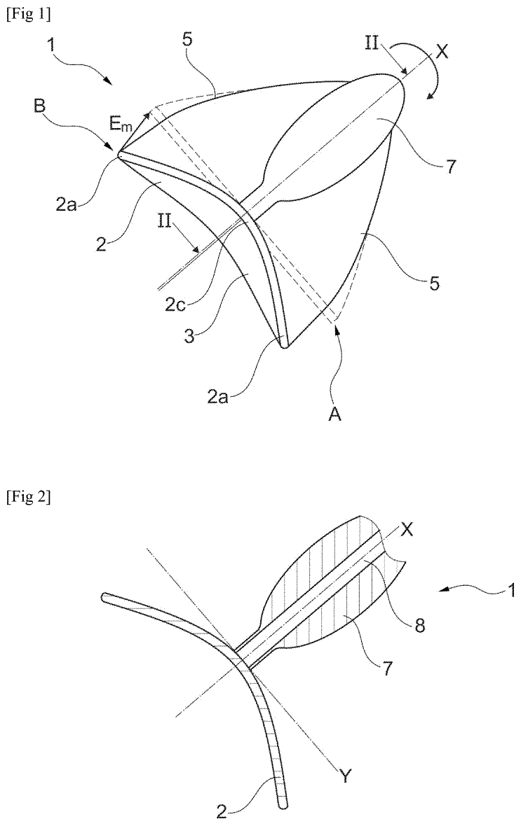

FIG. 1 illustrates an example of a device 1 according to the invention for picking up and applying a cosmetic composition P.

In this example, the device 1 has a support 2 defining an application surface 3 intended to receive the cosmetic composition P, and two elements 5, 7 that are movable with respect to one another in order to deform the support 2 in order to change from a pick-up configuration A to a makeup application configuration B. The device is configured so as to exert a force on the support 2 such that the latter passes from one configuration to the other. The first configuration A, shown by way of broken lines, is intended for picking up the cosmetic composition P. The second configuration B, shown by way of solid lines, is intended for application to an area of human keratin materials, an eyelid in this first example.

Preferably, and as illustrated, the application surface 3 is, in the second configuration of the support 2, curved, and more particularly concave towards the outside, so as to have a shape complementary to the morphology of the eyelid, whereas, in the first configuration of the support 2, the application surface 3 is substantially flat.

In the example in question, the support 2 is partially flexible, and the device has mechanical connections 5 that each connect one of the edges 2a of the support 2 to an actuating element 7, which also forms a gripping part of the device 1, connected to the support 2 at its centre 2c. In this example, the connections 5 are flexible, being for example wires.

The actuating element 7 of the device 1 is able to rotate about a geometric axis X with respect to a fixed physical axis 8 of the support. The rotation of the actuating element 7 stretches the connections 5 in that the latter exert a force on the support 2 so as to change it from one configuration to the other, as can be seen in FIGS. 1 and 2.

The maximum travel Eₘ between the two configurations A and B of the support 2 is between 5 mm and 20 mm. This travel Eₘ is measured at one of the ends 2a of the support 2, at its periphery, between the two configurations A and B, as illustrated in FIG. 1.

A user wishing to use the device 1 that has just been described brings it, in its configuration A, into contact with the cosmetic composition P, for example a print including a pattern, in order to pick it up. In this way, the pattern is transferred to the application surface 3 and the user then turns the actuating element of the gripping part in order to put the support 2 into its configuration B, then applies the application surface 3 bearing the pattern to the area to be made up by bringing them into contact with one another.

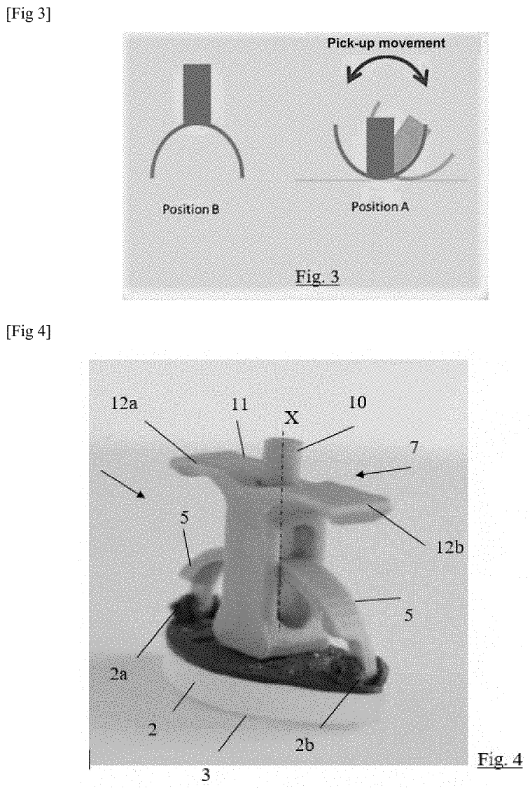

FIG. 3 shows an example in which, in the pick-up configuration A, the application surface, which is curved, has a shape opposite to that taken up in the configuration B of the support.

In the variant shown in FIG. 4, the connections 5 are rigid, each being formed by an arm connecting the actuating element of the device 1 to an end 2a of the support 2. The actuating element is in the form of a push button 10 that is movable relative to the body of the device 1, which defines the gripping part 7, the connections 5 being hinged to said body.

The body of the device defining the gripping part 7 is, in this example, provided with fins 12a and 12b for holding the device 1 when the user presses the push button 10. These fins define two ergonomic rests configured to receive the fingers of a user in order to hold the device 1 while another finger presses the push button 10.

In order to change configuration, the user presses the push button 10, causing the connections 5 to pivot and to deform the support 2.

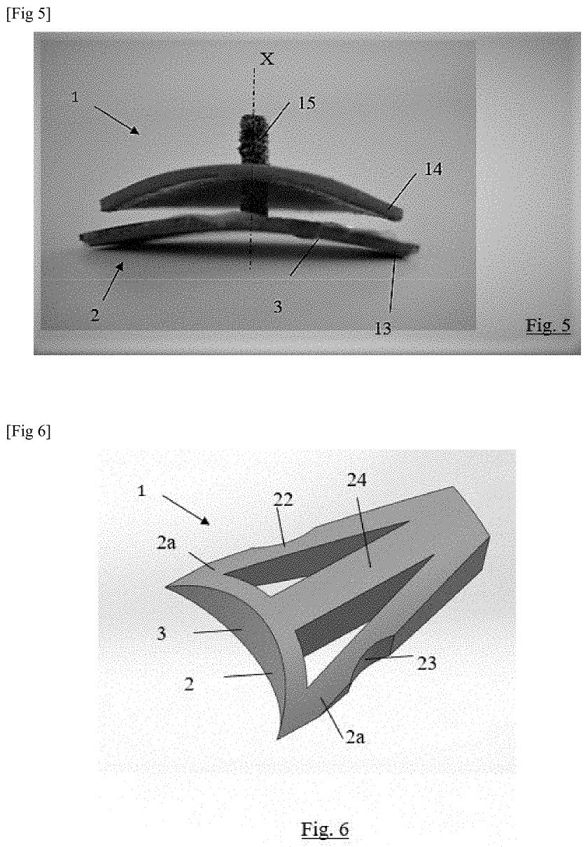

In the variant shown in FIG. 5, the support 2 has an elastically deformable membrane 13 defining the application surface 3 and the device 1 has, on the opposite side from said application surface, a bearing element 14 separate from the membrane 13 and made for example of a rigid material. The device 1 also has a rod 15 that carries the membrane 13 and is able to move relative to the element 14. As a result of the rod 15 being pulled towards the rear, the membrane 13 is pressed against the element 14 and takes on the shape thereof.

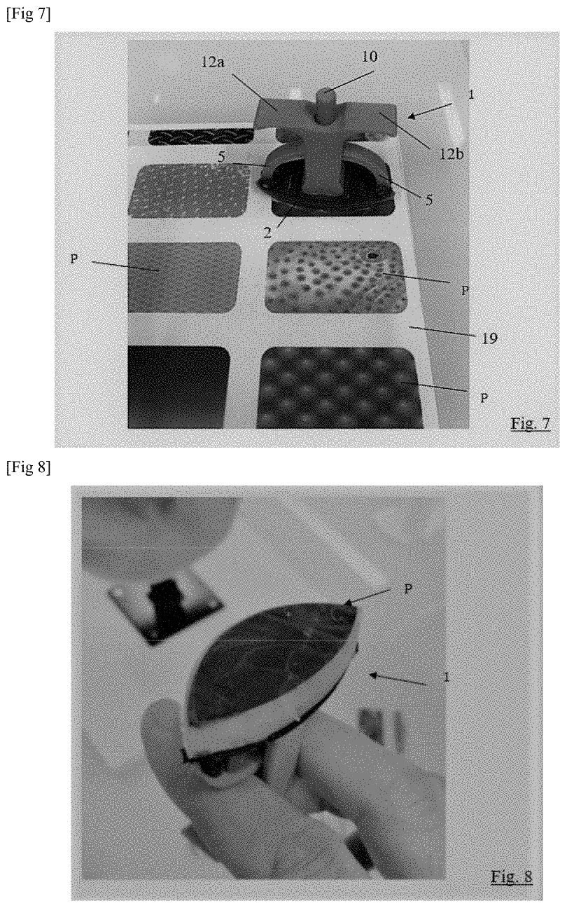

The rod advantageously has a relief (not shown) configured to lock the support 2 in the application configuration B, in particular by snap-fastening of the rod to the bearing element. In another variant, shown in FIG. 6, the device 1 has two elastically deformable connections 22, 23 that connect the support 2 by two respective contact points 2a to a fixed rod 24, the connections being configured to move towards one another when the user presses them between their thumb and index finger, causing the application surface, which is curved in a first configuration, to be flattened.

In the examples described, the movable elements are configured to restore to the support 2 a mechanical force applied by the user, via an actuating element 7 of the device 1.

In one embodiment of the invention, in the second configuration of the support 2, the application surface 3 has a shape adapted to a predefined area of the face or of the body of a user. In this case, the support is produced on the basis of an acquisition of the topography of at least a part of said area, in particular by way of a 3D scan.

As described above, at least a part of the device 1 having the application surface 3, or a mould for manufacturing it, can be produced by machining a preform or by additive manufacturing, in particular by 3D printing.

### EXAMPLE

An example of making up an eyelid with the aid of a device 1 according to the invention will now be described with reference to FIGS. 7 to 9.

In this example, the cosmetic composition P is in the form of various prints of coloured patterns on a plastic film 19, which have been printed with the aid of a laser printer having a deactivated fuser and are visible in FIG. 7. The device 1 used corresponds to the one in FIG. 4.

The user presses the push button 10 in order to put the support 2 into its configuration A, and brings the application surface 3 into contact with one of the prints in order to pick up the pattern thereof, as can be seen in FIG. 7. In this configuration, the application surface 3 is substantially flat. The pattern is thus transferred onto the application surface 3, as can be seen in FIG. 8.

The device 1 is then manipulated so as to put the support 2 into its configuration B by releasing the push button 10 in order to be able to apply the pattern to the area to be made up by bringing them into contact with one another. In this case, the application surface 3 has a shape corresponding exactly to the eyelid, that is to say a shape that is concave towards the outside.

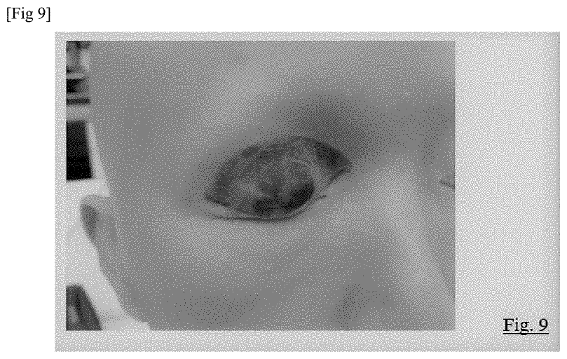

Once the device 1 has been removed, makeup that perfectly reproduces the desired pattern is obtained, as illustrated in FIG. 9, without any deterioration.

The application surface 3 can then be cleaned for a subsequent application.

The invention is not limited to the examples that have just been described.

Other types of support 2 and of movable elements can be used, as can other materials for the production thereof.

1. A device for picking up and applying a cosmetic composition, in particular makeup, in particular in the form of a transferable print, the device having a flexible support defining an application surface intended to receive the cosmetic composition, and at least two elements that are movable with respect to one another and are connected to the support, such that a relative movement of these two elements brings about a mechanical stress on the support and causes the latter to deform between a configuration for picking up the cosmetic composition and an application configuration, the application surface being substantially flat in the first configuration of the support and having a morphological shape, adapted to the area to which the composition is intended to be applied, in the second configuration of the support.

2. The device according to claim 1, wherein, in the first configuration of the support, the application surface forms a developable surface.

3. The device according to claim 1, wherein, in the second configuration of the support, the application surface has a shape that is concave or convex towards the outside.

4. The device according to claim 1, wherein, in the second configuration of the support, the application surface has a shape that is suitable for the application of the cosmetic composition to an eyelid.

5. The device according to claim 1, wherein, in the second configuration of the support, the application surface has a shape that corresponds exactly to a predefined area of the face or of the body of a user.

6. The device according to claim 1, wherein one of said two movable elements has two mechanical connections that connect the support by two respective contact points to an actuating element that is movable relative to the support and configured to be actuated by the user in order to change the configuration of the support.

7. The device according to claim 6, wherein the connections are flexible.

8. The device according to claim 6, wherein the actuating element is rotatable about a geometric axis respect to a physical axis fixed to the support so as, when driven in rotation, to stretch the connections such that the latter exert a pull on the support at the periphery thereof so as to change it from one configuration to the other.

9. The device according to claim 6, wherein the connections are rigid and are each formed by an arm connecting the actuating element) to the support, the device being configured such that a movement of said actuating element acts on the connections and the support.

10. The device according to claim 9, further comprising an actuating element in the form of a push button, which the user presses in order to deform the support, this push button preferably being movable relative to the body of the device defining a gripping part, the connections being hinged to said body and moved by the movement of the push button.

11. The device according to claim 10, wherein the body of the device is provided with fins for holding the device when the user presses the push button.

12. The device according to claim 1, wherein the support has an elastically deformable membrane defining the application surface and the device has, on the opposite side from said application surface, a bearing element separate from said membrane, in particular made of a rigid material, and a rod that carries the membrane and is able to move relative to the bearing element such that, as a result of the rod being pulled towards the rear, the membrane is pressed against the bearing element and takes on the shape thereof.

13. The device according to claim 1, wherein the movable elements are elastically deformable so as to be able to be moved towards one another.

14. The device according to claim 1, wherein said at least two movable elements are configured to exert on the support mechanical force applied by the user, in particular via a gripping part of the body of the device.

15. A method for manufacturing a device for picking up and applying a cosmetic composition according to claim 1, wherein the application surface of the support, in the application configuration, is given a shape corresponding exactly to the area of the body or of the face to which the composition is intended to be applied, said area being in particular an eyelid.

16. The method according to claim 15, wherein the support is produced on the basis of an acquisition of the topography of at least a part of said area, in particular by way of a 3D scan.

17. The method according to claim 15, wherein at least a part of the device having the application surface, or a mould for manufacturing it, is produced by machining a preform or by additive manufacturing, in particular by 3D printing.

18. A cosmetic set having, within one and the same packaging, at least one pick-up and application device according to claim 1, and a plurality of transferable prints that are intended to be picked up by the application surface of the support in its first configuration and in particular differ from one another in terms of their composition and/or their pattern.

19. The set according to claim 18, wherein the prints are obtained using a laser printer or inkjet printer.

20. A method for the cosmetic treatment of an area of human keratin materials, involving the application of a cosmetic composition to said area with the aid of a pick-up and application device according to claim 1, wherein, in said method, the device is used in its first configuration to pick up said composition, the latter being in particular in the form of a transferable print, and then the device is put into its second configuration by acting on at least one of said two movable elements, before the composition is applied.
